(19) United States
(12) Patent Application Publication
(10) Pub. No.: US 2025/0187839 A1
(43) Pub. Date: Jun. 12, 2025

(54) TRANSPORTING DEVICE

(71) Applicant: BRYCE TORRES, Tallahassee, FL (US)

(72) Inventor: BRYCE TORRES, Tallahassee, FL (US)

(21) Appl. No.: 18/661,824

(22) Filed: May 13, 2024

Related U.S. Application Data
(60) Provisional application No. 63/466,034, filed on May 12, 2023.

(51) Int. Cl. B65G 7/12; A45F 5/10; E06C 5/00

(52) U.S. Cl. CPC B65G 7/12; A45F 5/10; E06C 5/00

(57) ABSTRACT

A transporting device has a first handle assembly and a second handle assembly configured to cooperate together for supporting and transporting objects. The first handle assembly has a first support section and a first handle removably secured to the first support section for undergoing pivotal movement relative to the first support section. The first support section is configured to be removably secured to a first object to be transported by the transporting device. The second handle assembly has a second support section and a second handle removably secured to the second support section for undergoing pivotal movement relative to the second support section. The second support section is configured to be removably secured to a second object to be transported by the transporting device.

### BACKGROUND

### Technical Field

The present invention relates generally to transporting devices. More particularly, the present invention is configured for transporting in a safe and comfortable manner objects, such as ladders having side rails.

### Background Information

There are many objects which require transportation from one location to another, such as, for example, construction sites. These objects include, but are not limited to, ladders with side rails.

Ladders are generally carried to and from storage locations or vehicles and places they are used. They are inherently one of the most important tools for a craftsman, yet one of the hardest to carry. Ladders generally have a pair of side rails with rungs extending between the side rails. In general, ladders are difficult to control and can swing, or rise and fall in a variety of directions and not only injure the person carrying the ladder but also persons or property in the field of movement of the ladder.

People carry ladders at their side with just their hands. This causes the ladder's side rail to dig into the hands of the user making it painful to the user's hands even when wearing gloves. Another way to carry a ladder is on the user's shoulders. This is typically done when it hurts the user's hands too much to continue carrying the ladder with just the hands. However, carrying the ladder on the shoulders results in pain to the user's shoulders, neck and back, in addition to the user's vision being limited due to the obstruction of the ladder.

In addition, ladders are difficult to balance when they are being carried. When carrying ladders using hands, the ladders are rarely well balanced because the rungs of the ladders are in the way of grasping the ladder in a manner that provides balance. Unbalanced carrying causes the top or bottom of the ladder to tend to drag on the ground, requiring the user to apply a torque with the hand to prevent dragging. This makes it difficult and tiring to carry the ladder. Furthermore, if the ladder is too far behind relative to the user, it becomes necessary to constantly try to pull the ladder down in front of the user which creates a constant strain on the user's entire body in addition to supporting the weight of the ladder. The same balancing problem occurs when the ladder is too far ahead of the user. It has been therefore difficult to know the best or optimum support point of the ladder and it is dependent on the user carrying the ladder and the terrain.

Thus, it is desirable to provide a transporting device for transporting in a safe and comfortable manner objects, such ladders having side rails.

### SUMMARY

According to an aspect of the present invention, a transporting device for transporting objects is provided. In one embodiment, the transporting device has a first handle assembly and a second handle assembly configured to cooperate together for supporting and transporting objects. The first handle assembly has a first support section and a first handle removably secured to the first support section for undergoing pivotal movement relative to the first support section. The first support section is configured to be removably secured to a first object. The second handle assembly has a second support section and a second handle removably secured to the second support section for undergoing pivotal movement relative to the second support section. The second support section is configured to be removably secured to a second object.

According to a feature of the embodiment, the first and second handle assemblies are structured and configured independent from one another, and further configured for use together to cooperatively hold and transport the respective first and second objects.

As another feature of the embodiment, the first and second handles are configured to be selectively pivoted relative to the respective first and second support sections between unfolded positions of the first and second handles to folded positions of the first and second handles. During use of the transporting device, the first and second handles are aligned together in the unfolded positions and configured to be simultaneously grasped by one hand of a user for transporting the first and second objects.

According to yet another feature of the embodiment, the transporting device comprises first means for permitting pivoting of the first support section relative to the first handle, and second means for permitting pivoting of the second support section relative to the second handle. In an exemplary example of the embodiment, the first means comprises a lug extending from the first handle, pair of spaced apart lugs extending from the first support section and configured to receive therebetween the lug of the first handle, and a first pivot shaft interconnecting the lug of the first handle with the lugs of the first support section to permit rotational movement of lug of the first handle relative to the lugs of the first support section, thereby permitting pivotal movement of the first handle relative to the first support section. The second means comprises a lug extending from the second handle, pair of spaced apart lugs extending from the second support section and configured to receive therebetween the lug of the second handle, and a second pivot shaft interconnecting the lug of the second handle with the lugs of the second support section to permit rotational movement of lug of the second handle relative to the lugs of the second support section, thereby permitting pivotal movement of the second handle relative to the second support section.

According to another feature of the embodiment, each of the first support section and the first handle of the first handle assembly is an integrated structure formed from a single piece of material, and each of the second support section and the second handle of the second handle assembly is an integrated structure formed from a single piece of material. In an example of this feature, the single piece of material is plastic material. In a further example, the plastic material is polyethylene.

In another aspect, the present invention provides a transporting device as described above for transporting a ladder having side rails as the first and second objects. The first and second handle assemblies are configured to cooperate together by the first and second handles being configured to be aligned relative one another by pivotal movement thereof relative to the respective first and second support sections so that both the first and second handles can be grasped by a user using a single hand to transport the ladder. As a feature of the invention according to this aspect, each of the first handle assembly and the second handle assembly is configured to be secured independently from one another to the corresponding side rail of the ladder.

The foregoing and other features and advantages of the transporting device according to the present invention will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a left front perspective view of a transporting device according to an embodiment of the present invention.

FIG. 2 is a view like FIG. 1 but showing the transporting device holding two rail-shaped objects during use.

FIG. 3 is right rear perspective view of the transporting device in FIG. 2;

FIG. 4 is a rear view of the transporting device in FIG. 2;

FIG. 5 is a left front perspective view of a first handle assembly of the transporting device in FIG. 1;

FIG. 6 is a right-side view of the first handle assembly in FIG. 5;

FIG. 7 is a left side view of the first handle assembly in FIG. 5;

FIG. 8 is a top view of the first handle assembly in FIG. 5;

FIG. 9 is a perspective view similar to FIG. 5, but showing a handle of the first handle assembly pivoted relative to a support section of the first handle assembly;

FIG. 10 is a front view of the first handle assembly in FIG. 9;

FIG. 11 is a left side view in partial perspective of the first handle assembly in FIG. 9;

FIG. 12 is a top view of the first handle assembly in FIG. 9;

FIG. 13 is a right side exploded view of the first handle assembly in FIG. 9;

FIG. 14 is a right-side perspective exploded view of the first handle assembly in FIG. 9;

FIG. 15 is a left front perspective view of a second handle assembly of the transporting device in FIG. 1;

FIG. 16 is a right-side view of the second handle assembly in FIG. 15;

FIG. 17 is a left side view of the second handle assembly in FIG. 15;

FIG. 18 is a bottom view of the second handle assembly in FIG. 15;

FIG. 19 is a right front perspective view of the second handle assembly similar to FIG. 15, but showing a handle of the second handle assembly pivoted relative to a support section of the second handle assembly;

FIG. 20 is a right-side view in partial perspective of the second handle assembly in FIG. 19;

FIG. 22 is a bottom of the second handle assembly in FIG. 19;

FIG. 23 is a right side exploded view of the second handle assembly in FIG. 19;

FIG. 24 is a right-side perspective exploded view of the second handle assembly in FIG. 19;

FIG. 25 is a perspective view showing the first and second handle assemblies of the transporting device of FIG. 1 mounted to respective side rails of the ladder in a state in which the ladder is ready for transportation using the transporting device;

FIG. 26 is a perspective view like FIG. 25, but showing the handles of the first and second handle assemblies in a folded state relative to the respective support sections of the handle assemblies;

FIG. 27 is a perspective view of the ladder in FIG. 26 in a partially opened state, with the first and second handle assemblies mounted on respective side rails of the latter; and

FIG. 28 shows the transporting device in use.

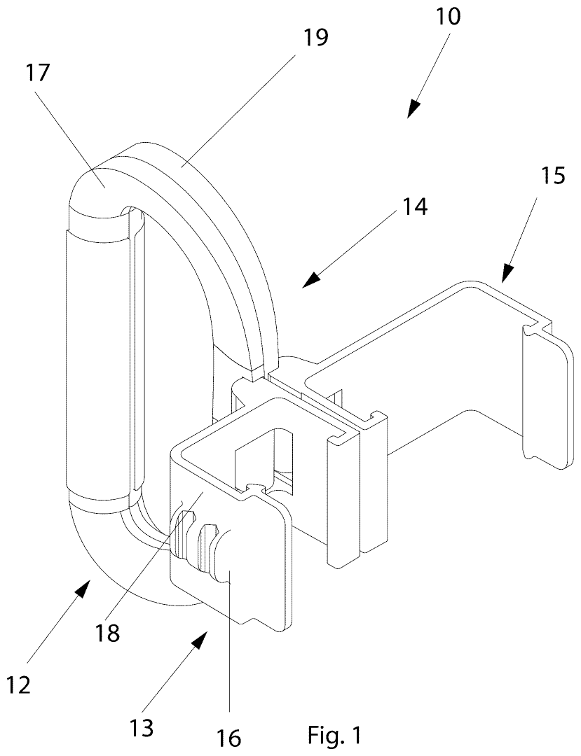

In FIGS. 1-28, the same reference numerals denote the same elements.

### DETAILED DESCRIPTION OF PREFERRED EMBODIMENTS

It is to be understood that both the foregoing general description and the following detailed description are exemplary and explanatory only and are not restrictive of the invention as claimed. The accompanying drawings, which are incorporated in and constitute a part of the specification, illustrate embodiments of the invention and together with the general description, serve to explain the principles of the invention. Throughout the drawings, the same reference numerals denote the same elements.

The present description may use perspective-based language such as front/rear, right/left, and top/bottom. Such language and language of similar import is merely used to facilitate the discussion, showing relative orientation and location of components to one another, and is not intended to restrict the application of embodiments of the present invention to particular orientations.

An embodiment of the present invention provides a transporting device for transporting in a safe and comfortable manner objects, such as ladders with side rails.

With reference now to the drawings, FIG. 1 shows an embodiment of the transporting device, generally designated with numeral 10, according to the present invention. Transporting device 10 includes two separate and independent handle assemblies 12, 14, i.e., first and second handle assemblies 12, 14. Each of the handle assemblies 12, 14 is configured to be removably secured to a corresponding object to be transported by transporting device 10. In this regard, it should be understood and appreciated that handle assemblies 12, 14 are not configured for direct connection to one another, but are rather configured to come into contact in alignment and cooperate with one another in a preselected configuration when removably secured to the corresponding objects for transporting the objects, FIG. 1 shows handle assemblies 12, 14 with the objects omitted to facilitate illustration of this preselected configuration of handle assemblies 12, 14.

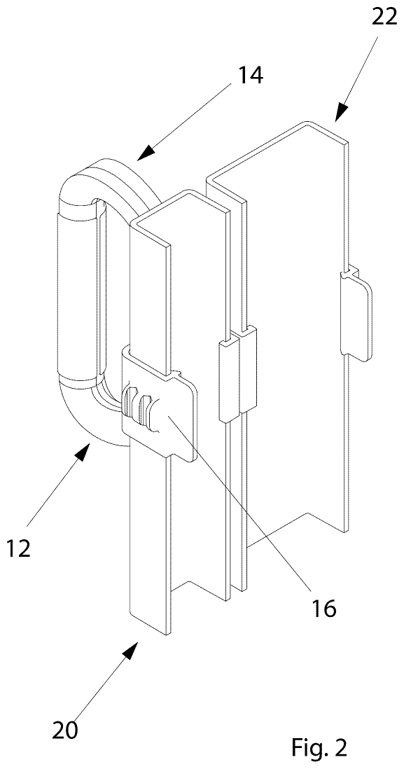

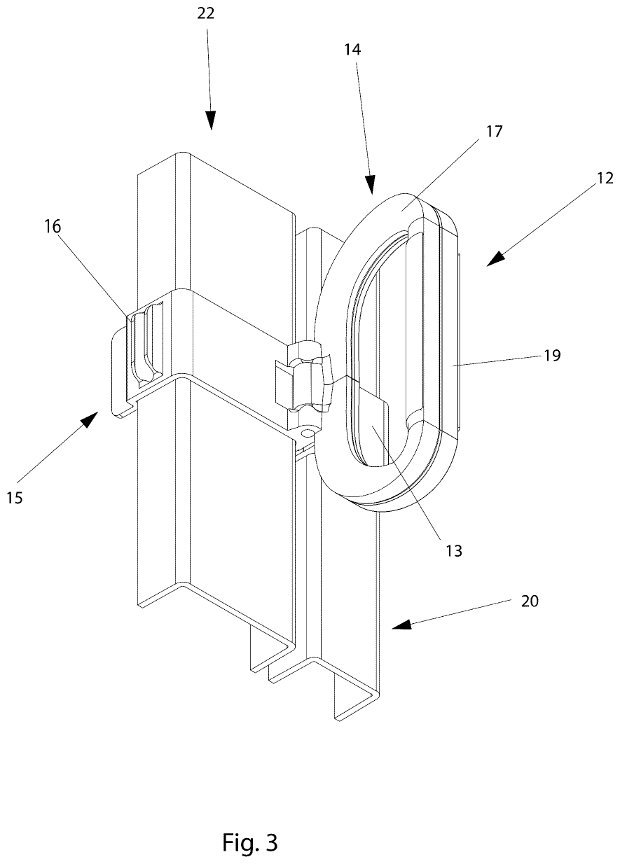

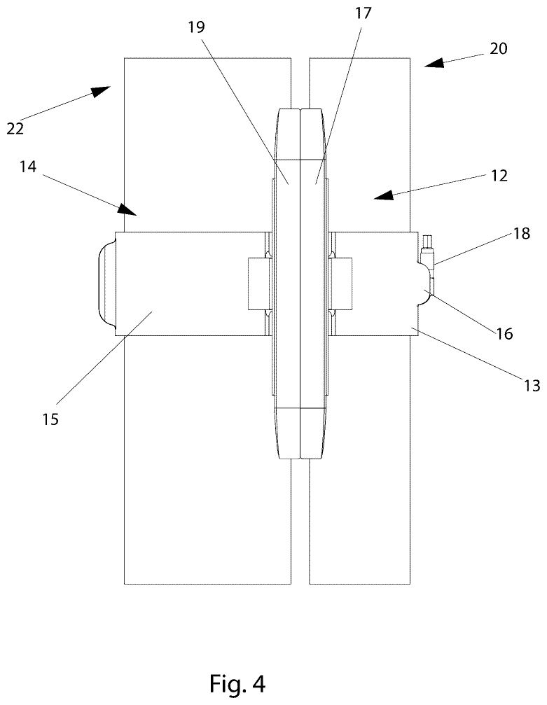

FIG. 2 is a figure like FIG. 1 and further illustrating an arrangement in which handle assemblies 12, 14 are removably secured to respective objects 20, 22, FIG. 3 is a right rear perspective view and FIG. 4 is a rear view of the arrangement shown in FIG. 2. FIGS. 2-4 illustrate how handle assemblies 12, 14 are configured to come into contact and cooperate with one another for transporting objects 20, 22. A more detailed description of the components and corresponding functions for each handle assembly 12, 14 is provided below.

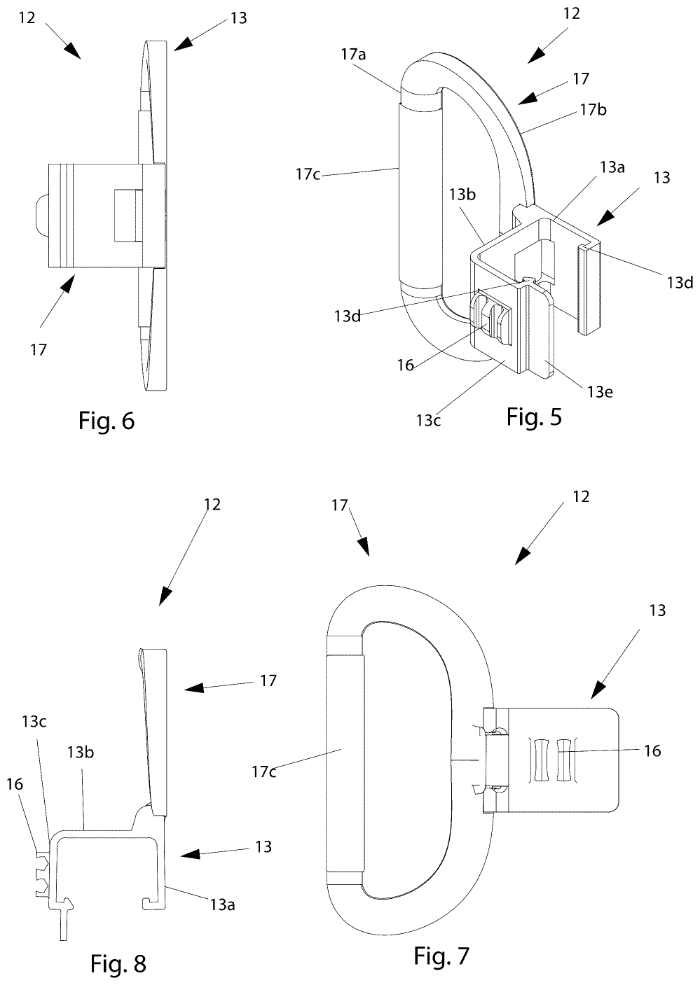

FIGS. 5-14 illustrate first handle assembly 12. Referring initially to FIG. 5, handle assembly 12 has a support section 13 (first support section) and a handle 17 (first handle) removably mounted to support section 13 for undergoing pivotal movement relative to support section 13.

Support section 13 is flexible and formed with flanges 13a-13c which in this embodiment are arranged to form support section 13 with an open, generally C-section profile configured for removable secure engagement with an object having a corresponding profile, such as shown and described above with reference to FIGS. 2-4. With its C-section profile, support section 13 is configured to exhibit sufficient flexibility to facilitate engagement and disengagement of support section 13 to the object. More specifically, flanges 13a, 13c are each provided with an extended section terminating in hook portions 13d for removable secure engagement with corresponding portions of the object to be transported as shown in FIG. 2. Flange 13c is also provided with a release portion 13e which, by virtue of the flexible nature of support section 13, facilitates disengagement of support section 13 from the object. Release portion 13e also facilitates the process of engagement of support section 13 to the object by allowing the user of transporting device 10 to engage hook portions 13d with the corresponding portions of the object by manipulation (e.g., flexing) of release portion 13e. Release portion 13e therefore defines means for facilitating removable engagement and disengagement of support section 13 to the object.

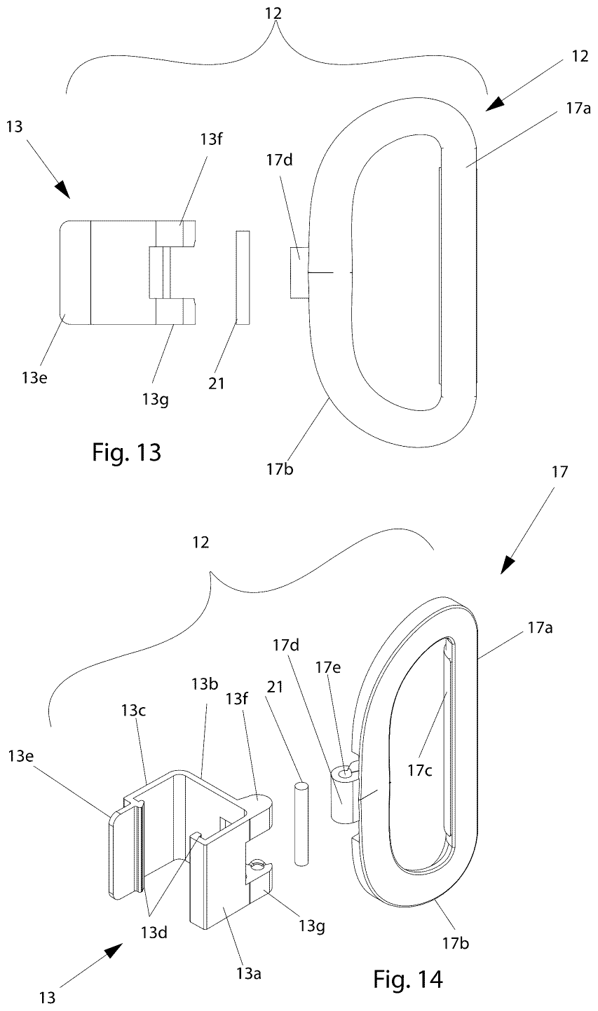

Referring to FIGS. 13 and 14, in the present embodiment handle 17 has a generally D-shaped configuration including straight section 17a and a curved section 17b contiguous with straight section 17a. Straight section 17a is preferably provided with a cushioning element 17c that at least partially wraps around straight section 17a and is configured to provide a comfortable place to grip by the user of transporting device 10. It will be appreciated that handle 17 can be configured with other than a D-shaped configuration, including C-shaped and modified forms of D-shaped and C-shaped configurations without limiting the scope of the present invention.

As described above, handle 17 is removably mounted to support section 13 for undergoing pivotal movement relative to support section 13. For this purpose, handle assembly 12 includes means for allowing relative pivotal movement between handle 17 and support section 13. In the present embodiment, the means for allowing relative pivotal movement is a pivot assembly provided between handle 17 and support section 13. The pivot assembly is formed by a lug 17d having a through-hole 17e and extending from a generally central portion of curved section 17b of handle 17, a pair of lugs 13f, 13g extending from flange 13b of support section 12 in spaced-apart relation to one another to accommodate therebetween lug 17d, and a pivot shaft 21 configured to extend through through-hole 17e of lug 17d and having terminal ends configured to extend into respective holes formed in lugs 13f, 13g. The pivot assembly and corresponding components described above define the means for allowing relative pivotal movement between handle 17 and support section 13.

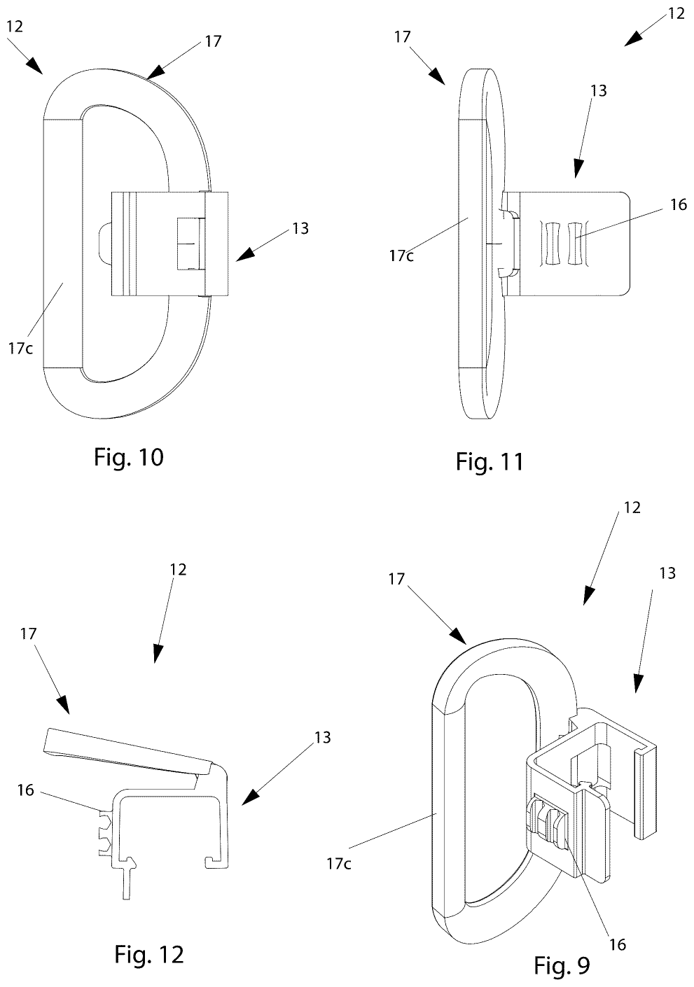

According to a feature of the present invention illustrated in FIGS. 5-12, lugs 13f, 13g extend from one end portion of flange 13b which is contiguous with flange 13a of support section 13. This configuration enables handle 17 to pivot about an axis of pivot shaft 21 from unfolded positions shown in FIGS. 5-8 to corresponding folded positions shown in FIGS. 9-12. In the unfolded position, handle 17 is configured to be aligned with a handle of second handle assembly 14, as further described below, during use of transporting device 10. FIG. 1 shows the aligned configuration of the two handles before the first and second handle assemblies are removably secured to the objects to be transported. FIGS. 2-4 show the aligned configuration of the two handles during use of transporting device 10 with the first and second handle assemblies removably secured to objects 20, 22 to be transported. The aligned configuration of the two handles as shown in FIGS. 2-4 permits the user to conveniently grasp the two handles with a single hand to transport objects 20, 22. The aligned configuration of the two handles to facilitate transportation of the objects is enabled by the specific location of the pivot assembly 12 of first handle assembly, as described above, and the corresponding specific location of a pivot assembly of the second handle assembly, as further described below.

As shown in FIGS. 1-7, 9, 11, 12, in the present embodiment support section 13 is provided with a holder 16 for removably holding various tools and/or fasteners, such as a drive tip 18 as shown in FIGS. 1 and 4. It is appreciated that holder 16 is optional and not necessary for the functioning of first handle assembly 12, including support section 12 and handle 17, as described above.

In the present embodiment, support section 13 of first handle assembly 12 is a unitary structure having a one-piece construction, including the various parts of support section 13 described above. Support section 13 can be molded from a single piece of material by any known injection molding technique, for example. Suitable materials for support section 13 include plastic, metals, and composites and/or combinations thereof, without limitation. For example, support section 13 can be made of polyethylene.

In the present embodiment, handle 17 of first handle assembly 12 is also a unitary structure having a one-piece construction, including the various parts of handle 17 described above. Handle 17 can also be molded from a single piece of material by any known injection molding technique, for example, Suitable materials handle 17 include plastic, metals, and composites and/or combinations thereof, without limitation. For example, handle 17 can be made of the same material as support section 13 (e.g., polyethylene.

In alternative embodiments, each of support section 13 and handle 17 can be made of multiple parts connected together and from one or more types of combinations of materials. For example, pivot assembly may be separate from support section 13 and handle 17 and connected thereto by suitable fastening elements, provided that the pivot assembly permits support section 13 and handle 17 to undergo pivotal movement relative one another, and provided that the pivot assembly is positioned relative to support section 13 and handle 17 to allow handle 17 to be aligned with a handle of second handle assembly 14 to facilitate transportation of objects 20, 22 by the user using transportation device 10, as described above.

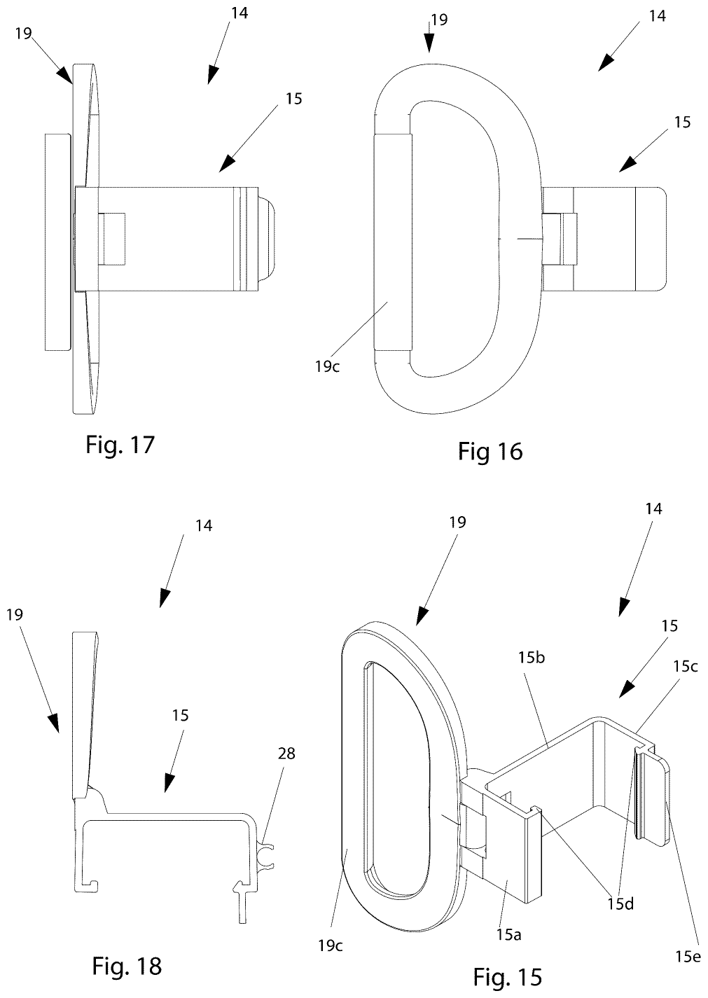

FIG. 15-24 illustrate second handle assembly 14. Referring initially to FIG. 15, handle assembly 14 has a second support section 15 and a second handle 19 removably mounted to support section 15 for undergoing pivotal movement relative to support section 15.

Support section 15 is generally flexible and is formed with flanges 13a-13c which in this embodiment are arranged to form support section 15 with an open, generally C-section profile, similar to support section 13 of first handle assembly 12, configured for removable secure engagement with an object having a corresponding profile, such as shown and described above with reference to FIGS. 2-4. With its C-section profile, support section 15 is configured to exhibit sufficient flexibility to facilitate engagement and disengagement of support section 15 to the object, More specifically, flanges 15a, 15c are each provided with an extended section terminating in a hook portion 15d for removable secure engagement with corresponding portions of the object to be transported as shown in FIG. 2. Flange 15c is also provided with a release portion 15e which, by virtue of the flexible nature of support section 13, facilitates disengagement of support section 15 from the object. Release portion 15e also facilitates the process of engagement of support section 15 to the object by allowing the user of transporting device 10 to engage hook portions 15d with the corresponding portions of the object by manipulation (e.g., flexing) of release portion 15e. Release portion 15e therefore defines means for facilitating removable engagement and disengagement of support section 15 to the object.

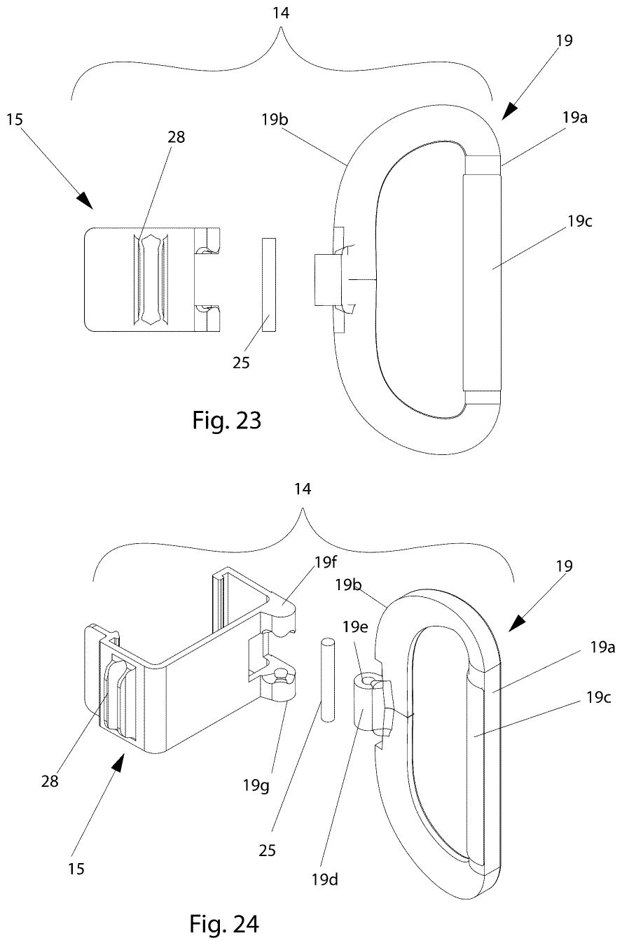

Referring to FIGS. 23 and 24, in the present embodiment handle 19 has the same configuration as described above for handle 17 of first handle assembly 12. Specifically, handle 19 has a generally D-shaped configuration including straight section 19a and a curved section 19b contiguous with straight section 19a. Straight section 19a is preferably provided with a cushioning element 19c that at least partially wraps around straight section 19a and is configured to provide a comfortable place to grip by the user of transporting device 10. It will be appreciated that handle 19 can be configured with other than a D-shaped configuration, including C-shaped and modified forms of D-shaped and C-shaped configurations without limiting the scope of the present invention, and provided that, as an embodiment of the present invention, handle 19 and handle 17 (of first handle assembly 12) are provided with the same configurations and dimensions.

Like first handle assembly 12, handle 19 is removably mounted to support section 15 for undergoing pivotal movement relative to support section 15. For this purpose, handle assembly 114 includes means for allowing relative pivotal movement between handle 19 and support section 15. In the present embodiment, the means for allowing relative pivotal movement is a pivot assembly provided between handle 19 and support section 15. The pivot assembly is formed by a lug 19d having a through-hole 19e and extending from a generally central portion of curved section 19b of handle 19, a pair of lugs 19f, 19g extending from flange 19b of support section 15 in spaced-apart relation to one another to accommodate therebetween lug 19d, and a pivot shaft 25 configured to extend through through-hole 19e of lug 19d and having terminal ends configured to extend into respective boles formed in lugs 19f, 19g. The pivot assembly and corresponding components described above define the means for allowing relative pivotal movement between handle 19 and support section 15.

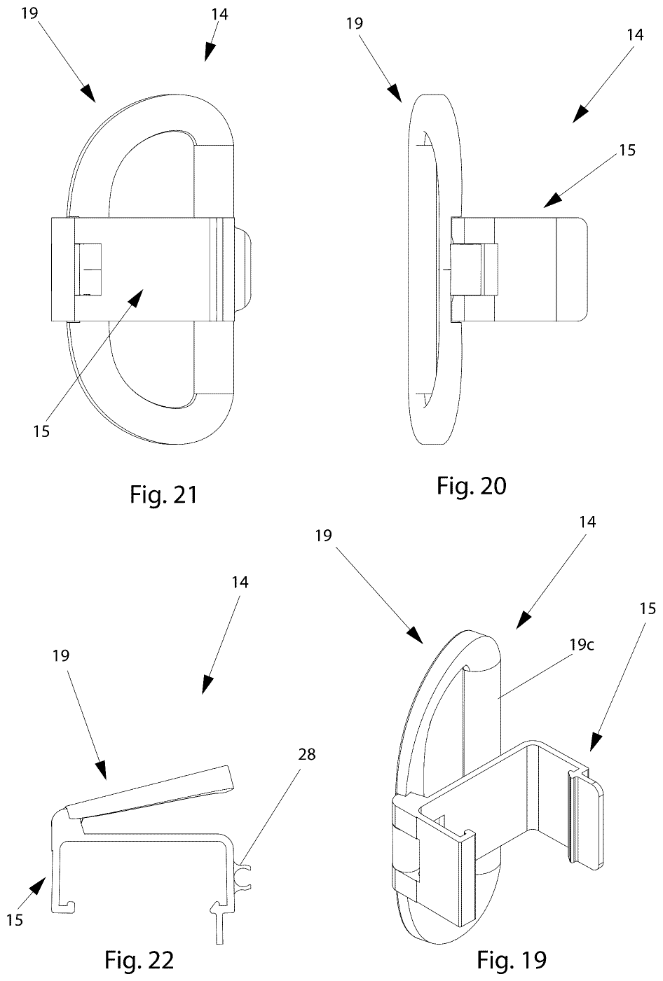

According to a feature of the present invention illustrated in FIGS. 15-22, lugs 19f, 19g extend from one end portion of flange 19b which is contiguous with flange 19a of support section 15. This configuration enables handle 19 to pivot about an axis of pivot shaft 25 from unfolded positions shown in FIGS. 15-18 to corresponding folded positions shown in FIGS. 19-22. In the unfolded position, handle 19 is configured to be aligned with handle 17 of first handle assembly 12 during use of transporting device 10. FIG. 1 shows the aligned configuration of the handles 17, 19 before the first and second handle assemblies 12, 14 are removably secured to the objects to be transported. FIGS. 2-4 show the aligned configuration of handles 17, 19 during use of transporting device 10 with first and second handle assemblies 12, 14 removably secured to objects 20, 22 to be transported. As noted above, the aligned configuration of handles 17, 19 shown in FIGS. 2-4 permits the user to conveniently grasp handles 17, 19 with a single hand to transport objects 20, 22. The aligned configuration of handles 17, 19 to facilitate transportation of the objects is enabled by the specific location of the pivot assemblies for first handle assembly 12 and corresponding specific location of the pivot assembly for second handle assembly 14 as described above.

As shown in FIGS. 18, 22, 23, 24, in the present embodiment support section 15 is provided with a holder 28 for removably holding various tools and/or fasteners in a manner similar as described above for holder 16 provided on support section 13 of first handle assembly 12. It is appreciated that, as described above for holder 16, holder 28 is optional and not necessary for the functioning of second handle assembly 14, including support section 15 and handle 19, as described above.

In the present embodiment, and like support section 15 and handle 17 of first handle assembly 12, each of support section 15 and handle 19 of second handle assembly 14 is formed as a unitary structure having a one-piece construction. Support section 15 and handle 19 can be molded from a single piece of material by any known injection molding technique, for example. Suitable materials for support section 15 and handle 19 include plastic, metals, and composites and/or combinations thereof, without limitation. For example, support section 15 and handle 19 can be made of a suitable plastic material, such as polyethylene. In alternative embodiments, each of support section 15 and handle 19 of second handle assembly 14 can be made of multiple parts connected together and from one or more types of combinations of materials, as described above for support section 13 and handle 17 of first handle assembly 12.

It is appreciated from the above description with reference to the drawings that, in the present embodiment, handles 17, 19 of first and second handle assemblies 12, 14, respectively, have identical configurations and dimensions, as generally denoted in FIGS. 1-4. This facilitates alignment of handles 17, 19 as set forth above during use of transporting device 10. Support sections 13, 15 of first and second handle assemblies 12, 14, respectively, have generally the same configuration (e.g., C-section profile), however, support section 15 has a larger dimension (e.g., a greater width) than support section 13, as generally denoted in FIGS. 1-4. The difference in dimensions between support sections 13, 15 is to accommodate objects of corresponding different dimensions. For example, by providing support sections 13, 15 with different dimensions, first and second handle assemblies 12, 14 can be removably secured to respective side rails of a ladder having corresponding different dimensions as further described below.

It will also be appreciated from the foregoing description with reference to the drawings that first handle assembly 12 and second handle assembly 12 of transporting device 10 are configured to be secured independently from one another to a corresponding object, such as the side rail of a ladder. That is, while cooperating together during transportation of the object(s) as noted above, first handle assembly 12 and second handle assembly 14 are structured and configured so as to be completely independent from one another, including for purposes of being secured to the corresponding objects, such as rails of a ladder. This structural configuration of first and second handle assemblies 12, 14 afford versatility to transporting device 10 during use as well as facilitate mass production of transporting device 10.

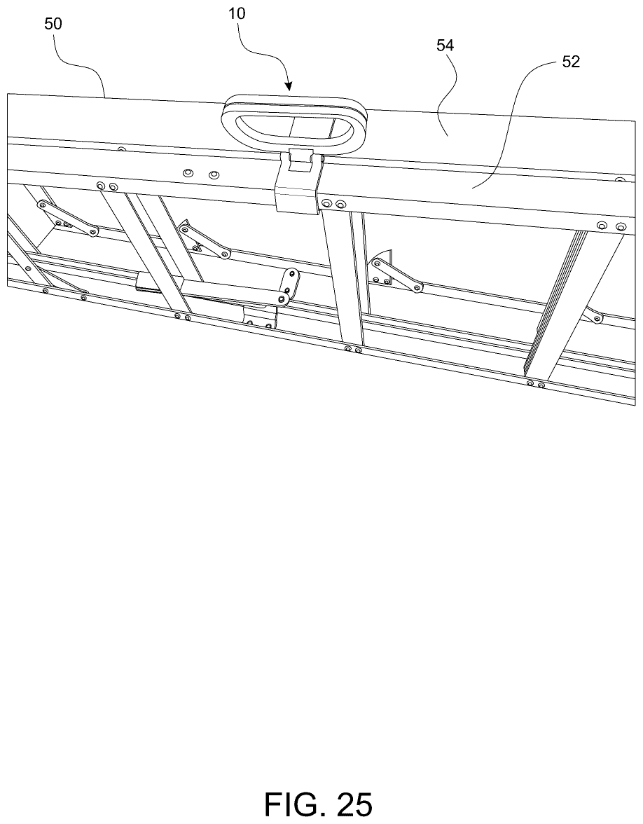

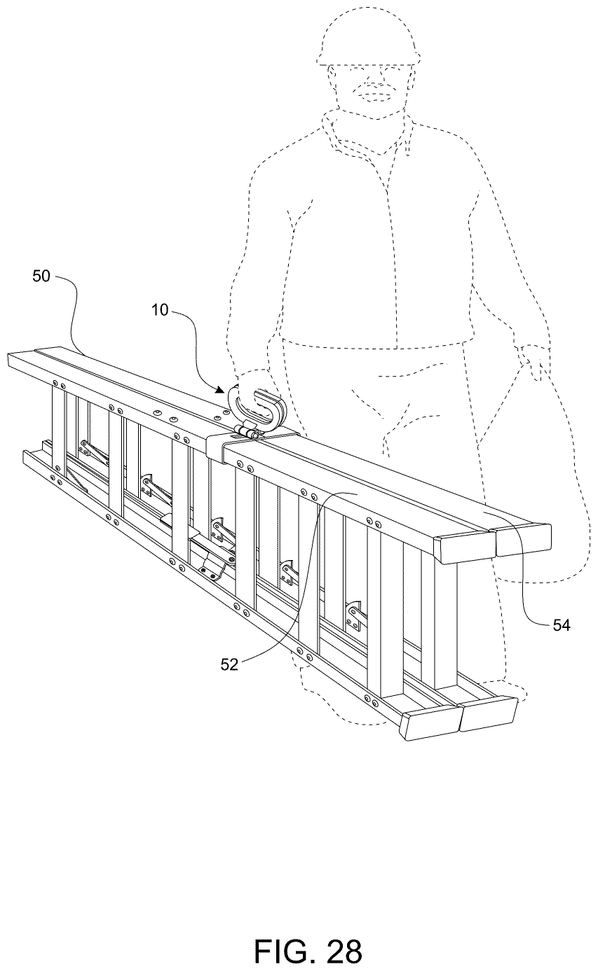

FIGS. 25-28 show a specific application of transport device 10 for transporting a ladder 50 having side rails 52, 54. In the illustrated embodiment, ladder 50 is an A-frame ladder. FIG. 28 shows the transporting device 10 in use.

FIG. 25 shows ladder 50 in a closed state with transporting device 10 applied thereto. Specifically, support sections 13, 15 are removably securely mounted to respective side rails 52, 54 of corresponding configuration and dimensions. To achieve this, hook portions 13d of support section 13 extend under and around corresponding portions of side rail 52, and hook portions 15d of support section 13 extend under and around corresponding portions of side rail 54. Handles 17, 19 are pivoted relative to support sections 13, 15 so as to be aligned with one another as described above. It will be appreciated that transporting device 10 is applied on a balance point of ladder 50 to conveniently balance ladder 50 for carrying by one hand of the user while standing in an upright position. By this configuration, ladder 50 is ready to be transported by transporting device 10.

It will be appreciated that in the assembled configuration of transporting device 10 shown in FIG. 25, in addition to being aligned with one another, handles 17, 19 all also generally aligned along a junction between folded side rails 52, 54 of ladder 50. This configuration further allows ladder 50 to be conveniently balanced during transportation.

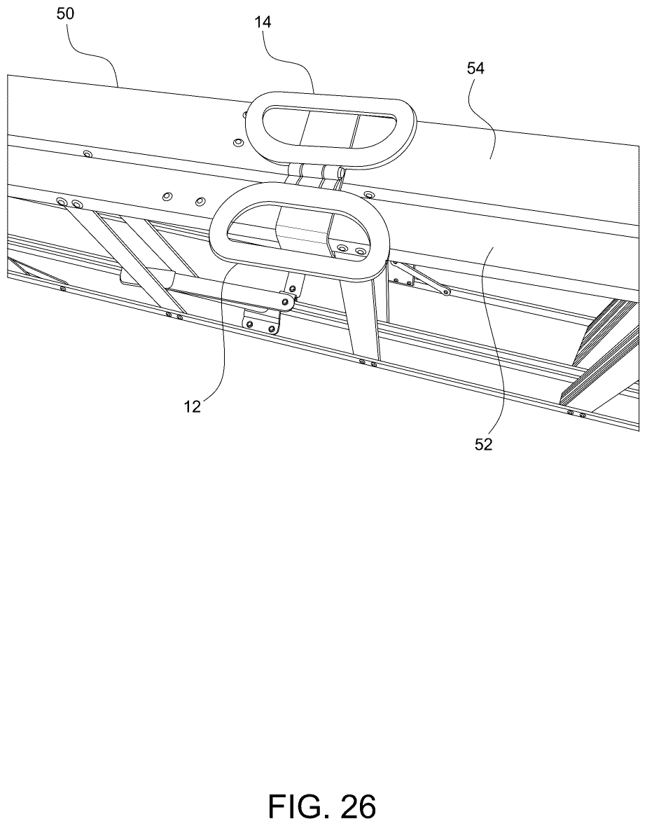

FIG. 26 is a view like FIG. 25, with the exception that handles 17, 19 are shown pivoted (i.e., folded) away from one another from the aligned position shown in FIG. 25. For first handle assembly 12, this is accomplished by turning handle 17 about pivot pin 12 so that handle 17 is pivoted relative to support section 13 to achieve the configuration in FIG. 26. For second handle assembly 14, this is accomplished by turning handle 19 about pivot pin 25 so that handle 19 is pivoted relative to support section 15 to achieve the configuration in FIG. 26. In the folded configuration, handles 17 and 19 are disposed generally parallel to respective surfaces of side rails 52, 54 of ladder 50, as shown in FIG. 26.

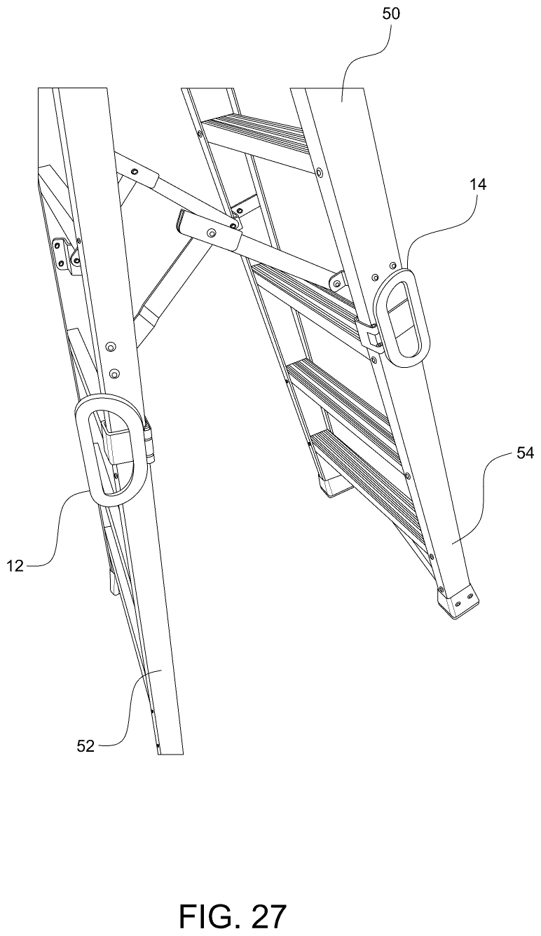

FIG. 27 shows ladder 50 in an open state. This figure illustrates how first and second handle assemblies 12, 14 remain securely mounted to corresponding side rails 52, 54 during use of ladder 50. Handles 17, 19 can be conveniently folded so that they are disposed generally parallel to respective surfaces of side rails 52, 54 of ladder 50, as described above and shown in FIGS. 26, 27, which avoids handles 17, 19 from standing in the way during use of ladder 50.

It will be further appreciated that first and second handle assemblies 12, 14 of transporting device 10 can conveniently remain securely attached to corresponding side rails 52, 54 of ladder 50 during use and storage of ladder 50 as well as during transportation of ladder 50 by transporting device 10. Specifically, first and second handle assemblies 12, 14 are configured for attachment to rails 52, 54 with sufficient compression force so that they do not inadvertently slide relative to rails 52, 54 during use and storage of ladder 50 as well as during transportation of ladder 50 by transporting device 10.

It will be appreciated that the components of transporting device 10 described herein with reference to the drawings can be produced in various sizes and shapes and with different materials incorporating different application considerations without departing from the scope of the present invention. In this regard, the selection of the dimensions, configuration, and materials selected for the support sections and handles of handle assemblies of transporting device 10 will depend on the dimensions, configurations, and materials of the corresponding objects to be transported, such as a ladder via side rails of the ladder.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A transporting device comprising:
a first handle assembly having a first support section and a first handle removably secured to the first support section for undergoing pivotal movement relative to the first support section, the first support section being configured to be removably secured to a first object to be transported by the transporting device; and
a second handle assembly having a second support section and a second handle removably secured to the second support section for undergoing pivotal movement relative to the second support section, the second support section being configured to be removably secured to a second object to be transported by the transporting device.

2. The transporting device of claim 1, wherein the first and second handle assemblies are configured for use together to hold and transport the respective first and second objects.

3. The transporting device of claim 2, wherein the first and second handles are configured to be selectively pivoted relative to the respective first and second support sections between unfolded positions of the first and second handles to folded positions of the first and second handles.

4. The transporting device of claim 3, wherein during use of the transporting device, the first and second handles are aligned together in the unfolded positions and configured to be simultaneously grasped by one hand of a user for transporting the first and second objects.

5. The transporting device of claim 1, further comprising first means for permitting pivoting of the first support section relative to the first handle, and second means for permitting pivoting of the second support section relative to the second handle.

6. The transporting device of claim 5, wherein the first means comprises a lug extending from the first handle, pair of spaced apart lugs extending from the first support section and configured to receive therebetween the lug of the first handle, and a first pivot shaft interconnecting the lug of the first handle with the lugs of the first support section to permit rotational movement of lug of the first handle relative to the lugs of the first support section, thereby permitting pivotal movement of the first handle relative to the first support section; and wherein the second means comprises a lug extending from the second handle, pair of spaced apart lugs extending from the second support section and configured to receive therebetween the lug of the second handle, and a second pivot shaft interconnecting the lug of the second handle with the lugs of the second support section to permit rotational movement of lug of the second handle relative to the lugs of the second support section, thereby permitting pivotal movement of the second handle relative to the second support section.

7. The transporting device of claim 6, wherein the first support member has three flanges forming a generally C-profile configured for releasable secure engagement with the first object having a corresponding rail profile, the lugs of the first support member extending from an end section of one of the flanges of the first support member that is contiguous with another of the flanges of the first support member; and wherein the second support member has three flanges forming a generally C-profile configured for releasable secure engagement with the second object having a corresponding rail profile, the lugs of the second support member extending from an end section of one of the flanges of the second support member that is contiguous with another of the flanges of the second support member.

8. The transporting device of claim 1, wherein the first support member has three flanges forming a generally C-profile configured for releasable secure engagement with the first object having a corresponding rail profile, hook portions extending from preselected two of the flanges for engagement with corresponding rail sections of the first object, and a release portion extending from one of the preselected two of the flanges and configured to be manipulated by a user of the transporting device when the first support member is secured and removed from the first object; and wherein the second support member has three flanges forming a generally C-profile configured for releasable secure engagement with the second object having a corresponding rail profile, hook portions extending from preselected two of the flanges of the second support member for engagement with corresponding rail sections of the second object, and a release portion extending from one of the preselected two of the flanges of the second support member and configured to be manipulated by a user of the transporting device when the second support member is secured and removed from the second object.

9. The transporting device of claim 1, wherein each of the first support section and the first handle of the first handle assembly is an integrated structure formed from a single piece of material; and wherein each of the second support section and the second handle of the second handle assembly is an integrated structure formed from a single piece of material.

10. The transporting device of claim 9, wherein the single piece of material is plastic material.

11. The transporting device of claim 10, wherein the plastic material is polyethylene.

12. The transporting device of claim 1, wherein the first and second objects are side rails of a ladder.

13. The transporting device of claim 12, wherein the side rails of the ladder have different width dimensions; and wherein the first and second support sections of the first and second handle assemblies, respectively, have different dimensions corresponding to and accommodating the respective different dimensions of the side rails of the ladder.

14. A transporting device for transporting a ladder having side rails, the transporting device comprising:
a first handle assembly having a first support section and a first handle removably secured to the first support section for undergoing pivotal movement relative to the first support section, the first support section being configured to be removably secured to one of the side rails of the ladder; and
a second handle assembly having a second support section and a second handle removably secured to the second support section for undergoing pivotal movement relative to the second support section, the second support section being configured to be removably secured to another one of the side rails of the ladder;
wherein the first and second handle assemblies are configured to cooperate together during transportation of the ladder.

15. The transporting device according to claim 14, wherein the first and second handle assemblies cooperate together by the first and second handles being configured to be aligned relative one another by pivotal movement thereof relative to the respective first and second support sections so that both the first and second handles can be grasped by a user using a single hand to transport the ladder.

16. The transporting device according to claim 15, wherein each of the first handle assembly and the second handle assembly is configured to be secured independently from one another to the corresponding side rail of the ladder.
